(19) United States
(12) Patent Application Publication
(10) Pub. No.: US 2002/0100776 A1
(43) Pub. Date: Aug. 1, 2002

(54) Circular fish stringer

(76) Inventor: Gary Lee Young, Greenville, OH (US)

Correspondence Address: Law Offices of John D. Gugliotta, P.E., Esq., 202 Delaware Building, 137 South Main Street, Akron, OH, 44308, US

(21) Appl. No.: 09/771,284

(22) Filed: Jan. 26, 2001

(51) Int. Cl. A01K 97/04

(52) U.S. Cl. 224/103

(57) ABSTRACT

A fish stringer is provided with a circular frame, made of cast aluminum, approximately six inches in diameter, that forms the main component of the invention. A round, center handle provides a comfortable, easy way to carry the invention along with the catch of fish. A series of eight chain and hook assemblies with swivel joints, are evenly spaced around the perimeter of the frame and are made of brass and stainless steel. The spacing provides a means to separate the fish while they are stored in the water or being carried. A vinyl coated chain, approximately six feet in length, is attached to the main frame, and is provided with a clasp and swivel joint, to allow the invention to be attached to the side of a boat or dock. The long chain assures the fish will be kept in the water even during rough or choppy conditions, and is red in color for easy locating.

### RELATED APPLICATIONS

The present invention was first described in Disclosure Document Number 474,308 filed on May 19, 2000. There are no previously filed, nor currently any co-pending applications, anywhere in the world.

### BACKGROUND OF THE INVENTION

1. Field of the Invention

The present invention relates generally to fish stringers and, more particularly, to a circular fish stringer that incorporates a carrying handle, as well as the use of a red coated chain for protection of vessel hull surfaces as well as easy locating.

2. Description of the Related Art

A great number of people around the world enjoy fishing. Whether fishing for food or for the sport of it, the calmness and serenity of the sport coupled with the excitement of landing “the big one” makes fishing a popular pastime. No matter what type of fishing one participates in, a common piece of equipment is the fish stringer. This piece of equipment, generally a chain with hooks, allows for holding and securing of the fish in the water after being caught, and provides a means to carry the fish from the boat or fishing spot.

However, these fish stringers suffer from several problems. First, the fish are often overcrowded and tangled due to in-line, short spacing. Second, the chain is often not long enough, causing the stringer and the fish to come out of the water, especially in rough or choppy waters. Finally, the chain, coupled with the weight of the fish, cuts into the user's hands while carrying it.

A search of the prior art did not disclose any patents that read directly on the claims of the instant invention; however, the following references were considered related:

The following patents disclose the ornamental design for a fish stringer.

U.S. Pat. No. D 400,636 issued in the name of High;

U.S. Pat. No. D 318,314 issued in the name of Watkins; and

U.S. Pat. No. D 191,612 issued in the name of Pachner

The following patents describe the ornamental design for a fish stringer holder:

U.S. Pat. No. D 371,419 issued in the name of Hohag; and

U.S. Pat. No. D 324,715 issued in the name of Johnson.

U.S. Pat. No. 5,987,808 issued in the name of Coles discloses a fish stringer with a floating weight indicator.

U.S. Pat. No. 5,467,908 issued in the name of Cote describes a floating fish stringer.

U.S. Pat. No. 5,114,058 issued in the name of Davis discloses a fish stringer with a hand grip for horizontal carrying.

U.S. Pat. No. D 294,854 issued in the name of Friesz discloses the ornamental design for a fish stringer retainer bracket.

U.S. Pat. No. D 260,419 issued in the name of Oates describes the ornamental design for a fish stringer retainer.

Of considerable relevance is U.S. Pat. No. 4,328,916 issued in the name of Lucas describing a fishing tackle accessory comprising a plastic circular ring. Although many of these features are incorporated into the present invention, improvements are further incorporated incorporating an anchoring, or submerging means due to the weight of the cast aluminum body, as well as the use of a coated chain for protection of vessel hull surfaces.

Consequently, there exists a need for a means by which the features and benefits of a fish stringer can be expanded without any of its disadvantages.

### SUMMARY OF THE INVENTION

It is therefore an object of the present invention to provide an improved fish stringer.

It is a feature of the present invention to provide an improved circular fish stringer that incorporates an anchoring, or submerging means, as well as the use of a coated chain for protection of vessel hull surfaces.

Briefly described according to one embodiment of the present invention, a fish stringer is provided with a circular frame, made of cast aluminum, approximately six inches in diameter, that forms the main component of the invention. A round, center handle provides a comfortable, easy way to carry the invention along with the catch of fish. A series of eight chain and hook assemblies with swivel joints, are evenly spaced around the perimeter of the frame and are made of brass and stainless steel. The spacing provides a means to separate the fish while they are stored in the water or being carried. A vinyl coated chain, approximately six feet in length, is attached to the main frame, and is provided with a clasp and swivel joint, to allow the invention to be attached to the side of a boat or dock. The long chain assures the fish will be kept in the water even during rough or choppy conditions, and is red in color for easy locating.

The use of the present invention allows serious fishermen the ability to securely and safely store and transport any caught fish in a manner which is quick, easy and effective.

Another advantage of the present invention is that the design does not allow fish to drag on ground while being carried.

Also, an advantage of the use of corrosion resistant components gives the user a durable product with long life.

Yet another advantage of the present invention is that it includes a circular frame that provides an attachment point for a plurality of individual fish hooks.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a circular, submerged style fish stringer according to the preferred embodiment of the present invention;

FIG. 2 is a partial side elevational view thereof, the opposite side anticipated as being symmetric thereto; and

FIG. 3 is a cross sectional elevational view of a retention tether 22 according to its preferred embodiment as taken along line IV-IV of FIG. 1.

### DESCRIPTION OF THE PREFERRED EMBODIMENTS

The best mode for carrying out the invention is presented in terms of its preferred embodiment, herein depicted within the Figures.

1. Detailed Description of the Figures

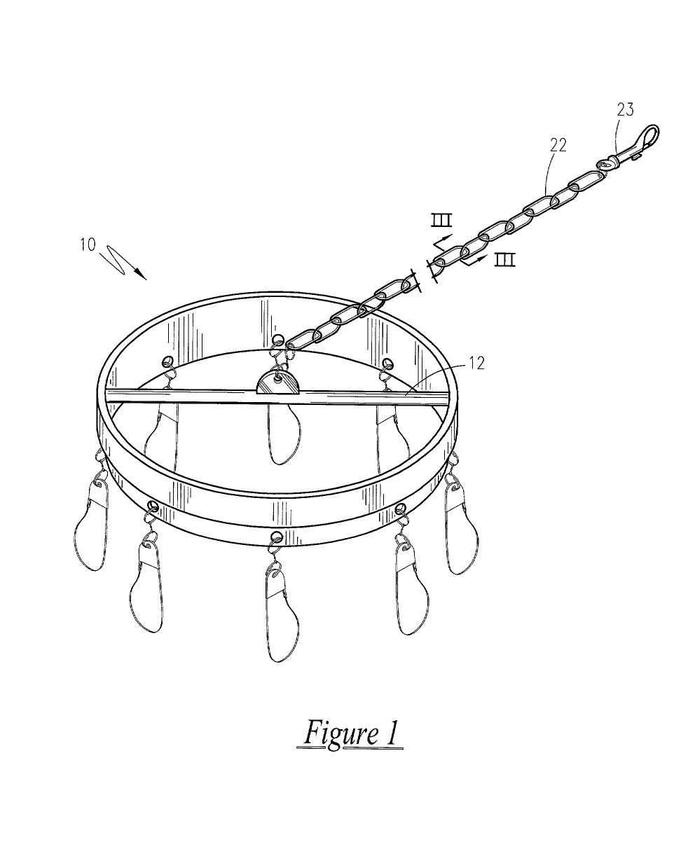

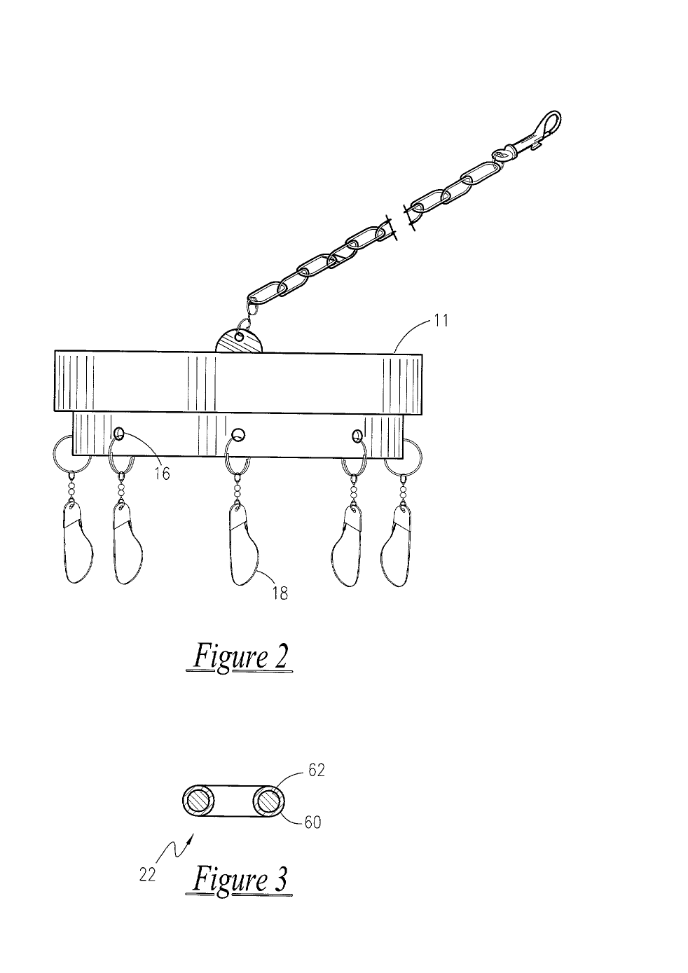

Referring now to FIG. 1-2, a fish stringer 10 is provided with a circular outer frame 11, made of cast aluminum, band steel, or injection molded plastic, approximately six inches in diameter, that forms the main structural component of the invention. The outer frame 11 forms a generally flat vertical sidewall 13 about an upper peripheral rim 14. The sidewall 13 forms a plurality of spaced openings 16 designed each to accommodate and support a fish retention means 18, such as a snap hook and chain assembly with swivel joints as shown evenly spaced around the perimeter of the frame 11. The spacing provides a means to separate the fish while they are stored in the water or being carried.

A diametrically extending combination support bar and carrying handle 12 spans and connects to the circular outer frame 11 as described in greater detail below. The combination support bar and carrying handle 12 provides structural rigidity, as well as a means for connecting to the geometric center a retention tether 22. The anchor tether 24 is anticipated as affixed at one end to the weight of the stringer keeps the fish in deep and colder water when placed in a river, lake, or the like. The retention tether 22 is terminated by a position securement means 23 of an otherwise conventional type.

The center carrying handle 12 provides a comfortable, easy way to carry the invention along with the catch of fish. It is anticipated that the carrying handle 12 will span the outer frame 11 and connect thereto at or near the peripheral rim 14, cast as part of the body. . As shown in FIG. 3a, if the handle 40 and support bar 11 are radially aligned. In such a configuration, the stringer 10 is balanced and easily handled by the user during transport.

Finally referring now to FIG. 4, a cross sectional elevational view of a retention tether 22 according to its preferred embodiment as taken along line IV-IV of FIG. 1. A red vinyl coating 60 surrounding chain links 62, provided with a clasp and swivel joint, to allow the invention to be attached to the side of a boat or dock. The long chain assures the fish will be kept in the water even during rough or choppy conditions.

2. Operation of the Preferred Embodiment

The use of the present invention allows serious fishermen the ability to securely and safely store and transport any caught fish in a manner which is quick, easy and effective. Secured to a boat or other fixed object, the vinyl coating 60 prevents damage to the boat sidewalls. The weight of the cast aluminum body keeps fish in deeper, colder water.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. A fish stringer comprising:
a circular outer frame forms a generally flat vertical sidewall about an upper peripheral rim, said sidewall forming a plurality of spaced openings designed each to accommodate and support a fish retention means;
a diametrically extending combination support bar and carrying handle spanning and connecting to said circular outer frame for providing structural rigidity and a geometric center; and
a retention tether connecting to a geometric center combination support bar and carrying handle spanning.

2. The fish stringer of claim 1, wherein said fish retention means comprises as a snap hook and chain assembly with swivel joints.

3. The fish stringer of claim 1, wherein said frame is formed of cast aluminum.

4. The fish stringer of claim 1, wherein said retention tether is terminated by a position securement means.

5. The fish stringer of claim 1, wherein said retention tether comprises a red vinyl coating surrounding chain links and provided with a clasp and swivel joint.
